(19) United States
(12) Patent Application Publication
(10) Pub. No.: US 2008/0230590 A1
(43) Pub. Date: Sep. 25, 2008

(54) METHOD FOR FABRICATING DISSIMILAR MATERIAL JOINTED BODY

(75) Inventors: Hironori Takahashi, Nagoya-city (JP); Masayuki Hironaga, Tokai-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/104,994

(22) Filed: Apr. 17, 2008

Related U.S. Application Data
(63) Continuation of application No. PCT/JP2007/055268, filed on Mar. 15, 2007.

(30) Foreign Application Priority Data
Mar. 15, 2006 (JP) 2006-071803

(51) Int. Cl. B23K 20/02

(52) U.S. Cl. 228/194; 228/193

(57) ABSTRACT

A method for producing a bonded body of different materials of the present invention is a method for producing a bonded body of different materials (1), where two plate members (2 and 3) are bonded to each other, the method including: laminating two plate members (2 and 3) consisting of different materials to obtain a plate-member-laminated-body (4), and heating the plate-member-laminated-body (4). The method includes a step of heating the plate-member-laminated-body (4) while it is sandwiched between a pair of pressing dies (5). The pressing die (5) is made of a material having a heat transfer coefficient 1.5 times or more higher than that of at least one of the plate members (2 and 3) constituting the plate-member-laminated-body (4) and has a tapered part (6) between holding surface (15) which hold the plate-member-laminated-body (4) and a fixing end (16) for securing the pressing die (5). The outer diameter of the tapered part is reduced from the holding surface (15) toward the fixing end (16).

### TECHNICAL FIELD

The present invention relates to a method for producing a bonded body of different materials. More particularly, the present invention relates to a method for producing at low costs a bonded body of different materials having excellent bonding strength in the bonded interface.

### BACKGROUND ART

A bonded body obtained by laminating two plate members, each made of a material differing from the other, has been used for a member requiring wear resistance of only a part thereof, such as a die used for extrusion molding and the like (such a bonded body is hereinafter referred to as a bonded body of different materials) (see, for example, Patent Document 1 or 2).

Patent Document 1 discloses an aluminum metal bonded body prepared by bonding an aluminum metal member made of aluminum or containing aluminum as a major component and another member differing from the aluminum metal member, with a soft metal layer with Hv hardness (micro-Vickers hardness: load 100 gf) of 20 to 80 and a thickness of 0.1 to 3 mm being interposed between the aluminum metal member and the other member made of a different material.

Patent Document 2 discloses a metal-ceramic bonded body having a structure in which a metal body and a ceramic body are bonded with a brazing material layer interposed between them. Steel having properties of being hardened by cooling from its austenitic state at a predetermined cooling rate is used as the metal body. The steel and the brazing material are selected from the materials satisfying an inequality of 0.4 MPs<Ts<0.75 MPs, wherein MPs is the solidus temperature of the brazing material and Ts is the starting temperature of steel transformation from the austenitic state to a hardened phase formed when the steel is cooled at a cooling rate of 0.1 to 200° C./min.

When such a bonded body of different materials is produced, for example, a method where a laminate of two plate members made of different materials is prepared and the laminate is bonded by heating while holding the laminate between a pair of pressing dies can be used.
[Patent Document 1] JP-A-10-5992
[Patent Document 2] JP-A-2002-179473

### DISCLOSURE OF THE INVENTION

However, in a conventional method of producing a bonded body of different materials, since it has been difficult to uniformly heat the plate member sandwiched between a pair of pressing dies, the resulting laminated plate members may have fluctuation in the bonding strength in the laminated interface or may have incompletely bonded portions.

A method where a heater or the like is disposed around the plate members sandwiched between a pair of pressing dies to use radiant heat from the heater has been used. However, conventional dies used in production of a bonded body of different materials have only insufficient heat transfer rate and poor absorption efficiency of radiant heat, resulting in an increase in the energy cost during heating.

The present invention has been achieved in view of the aforementioned problems and provides a method for producing a bonded body of different materials having excellent bonding strength in the bonded interface at low costs.

That is, according to the present invention, there is provided the following methods for producing a bonded body of different materials.
[1] A method for producing a bonded body of different materials comprising obtaining a plate-member-laminated-body by laminating two plate members, each made of a different material, and heating the plate-member-laminated-body to obtain a bonded body of different materials consisting of the two plate members bonded; wherein the method includes a step of heating the plate-member-laminated-body in a state that the plate-member-laminated-body held between a pair of pressing dies, which are made of a material having a heat transfer coefficient (W/m²·K) 1.5 times or more higher than the heat transfer coefficient (W/m²·K) of at least one of the plate members constituting the plate-member-laminated-body, the pressing dies having tapered parts between holding surfaces holding the plate-member-laminated-body and fixing ends for securing the pressing dies, of which the outer diameter decreases from the holding surfaces toward the fixing ends.
[2] The method according to [1], wherein the pressing dies are made of a material having a heat transfer coefficient (W/m²·K) 1.5 times or more higher than the heat transfer coefficient (W/m²·K) of both of the plate members constituting the plate-member-laminated-body.
[3] The method according to [1] or [2], wherein the pressing dies are made of a material having a melting point of 500° C. or more and 1.5 times or more higher than the bonding temperature of the plate-members constituting the plate-member-laminated-body.
[4] The method according to any one of [1] to [3], wherein the material of the pressing dies is a material containing at least one selected from the group consisting of silver, copper, gold, aluminum, magnesium, brass, tungsten, beryllium, iridium, molybdenum, silicon, carbon, aluminum nitride, and silicon carbide.
[5] The method according to any one of [1] to [4], wherein the two plate members are laminated with a brazing material between them to obtain a plate-member-laminated-body with a brazing material between the two plate members.
[6] The method according to [1] or [5], wherein the plate-member-laminated-body is held with a releasing material provided in advance between a pair of pressing dies and a plate-member-laminated-body.
[7] The method according to [6], wherein the releasing material is in a form of a sheet or a powder of at least one selected from the group consisting of silicon, carbon, aluminum nitride, aluminum oxide, and silicon carbide.
[8] The method according to any one of [1] to [7], wherein the plate-member-laminated-body is held by a pressure of 0.1 to 100 MPa applied by the pressing dies.
[9] The method according to any one of [1] to [8], wherein the material of one of the plate members is a metal or an alloy which can cause at least one phase transformation selected from a group consisting of martensitic transformation, bainite transformation, and pearlite transformation by cooling of an austenite phase.
[10] The method according to [9], wherein the other plate member is made of an ultra hard tungsten carbide alloy.
[11] The method according to any one of [1] to [10], wherein the material of one of the plate members is provided with a back hole to introduce a forming raw material and slits for forming the forming raw material in a lattice shape, and the resulting bonded body of different materials is used as material for a die for forming a honeycomb structure.

The method of the present invention can produce a bonded body of different members having excellent bonding strength in the bonded interface of the bonded two plate members at low costs.

In particular, the method for producing a bonded body of different materials of the present invention can heat the pressing dies more promptly than the plate-member-laminated-body during the heating step by using a pair of pressing dies prepared from the above-mentioned materials and having the above-mentioned configuration. In addition, since the heat can uniformly be transmitted to the plate-member-laminated-body from the heated pressing dies, the method can exhibit very high thermal efficiency.

### BRIEF DESCRIPTION OF THE DRAWINGS

FIG. 1 is a diagram schematically showing the process of producing the plate-member-laminated-body in one embodiment of the method for producing the bonded body of different materials of the present invention, wherein the plate-member-laminated-body is viewed from the side.

FIG. 2 is a side view of the bonded body of different materials obtained by one embodiment of the method for producing the bonded body of different materials of the present invention.

FIG. 3 is a diagram schematically showing the step of heating the plate-member-laminated-body held between a pair of pressing dies in one embodiment of the method for producing the bonded body of different materials of the present invention, wherein the plate-member-laminated-body is viewed from the side.

FIG. 4 is a diagram showing the heat transfer conditions during heating in one embodiment of the method for producing the bonded body of different materials of the present invention, wherein the plate-member-laminated-body is viewed from the side.

FIG. 5 is a diagram showing the heat transfer conditions during heating in one embodiment of the method for producing the bonded body of different materials of the present invention, wherein the plate-member-laminated-body is viewed from the side.

FIG. 6 is a diagram showing the heat transfer conditions during heating in one embodiment of the method for producing the bonded body of different materials of the present invention, wherein the plate-member-laminated-body is viewed from the side.

FIG. 7 is a diagram showing the process of producing the plate-member-laminated-body in a state in which a brazing material is disposed between the two plate members in one embodiment of the method for producing the bonded body of different materials of the present invention, wherein the plate-member-laminated-body is viewed from the side.

FIG. 8 is an oblique view schematically showing a die for forming a honeycomb structure.

FIG. 9 is an oblique view showing the honeycomb structure produced by extrusion forming using the die shown in FIG. 8.

FIG. 10 is a cross-sectional diagram vertical to the surface of the plate-member-laminated-body, schematically describing the process of producing the plate-member-laminated-body in another example of one embodiment of the method for producing the bonded body of different materials of the present invention.

FIG. 11 is a cross-sectional diagram vertical to the surface of the plate-member-laminated-body, schematically describing the step of heating the plate-member-laminated-body held between a pair of dies in another example of one embodiment of the method for producing the bonded body of different materials of the present invention.

FIG. 12 is a cross-sectional diagram vertical to the surface of the plate-member-laminated-body, schematically describing the step of forming slits in the other plate member in another example of one embodiment of the method for producing the bonded body of different materials of the present invention.

### EXPLANATION OF SYMBOLS

(1): bonded body of different materials, (2): plate member (one plate member), (3): plate member (other plate member), (4): plate-member-laminated-body, (5): pressing die, (6): tapered part, (7): heater, (8): releasing material, (9): brazing material, (10): radiant heat (12): honeycomb structure, (13): partition wall, (14): cell, (15): holding surface, (16): fixed end, (21): die, (25): slit, (26): back hole

### BEST MODE FOR CARRYING OUT THE INVENTION

One embodiment of the bonded body of different materials according to the present invention is described below in detail with reference to the drawings. However, the present invention should not be construed as being limited to the following embodiment. Various alterations, modifications, and improvements may be made within the scope of the present invention based on the knowledge of a person skilled in the art.

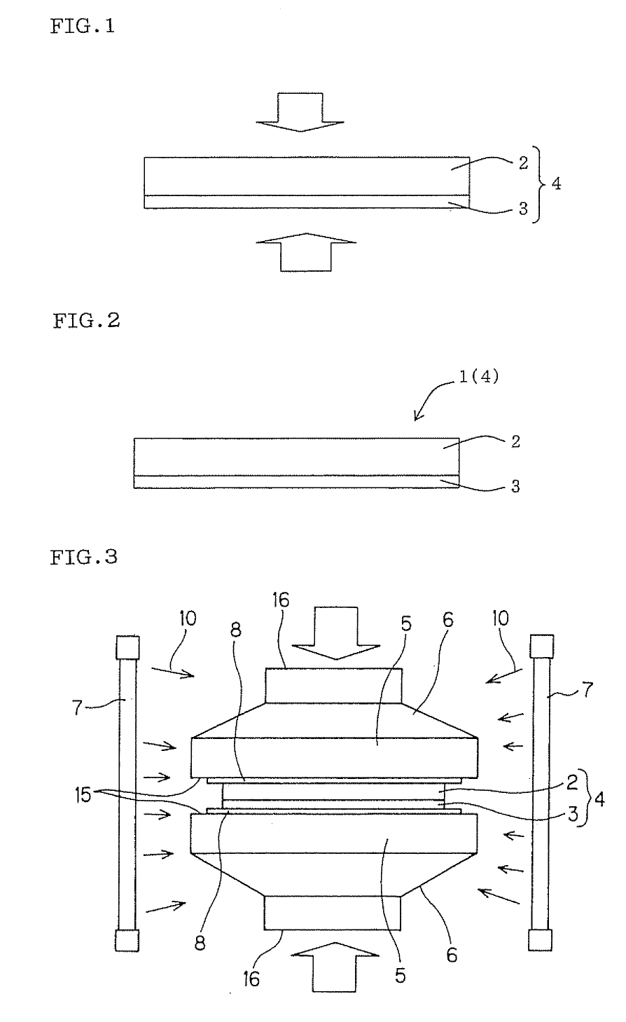

FIG. 1 is a diagram schematically describing the process for producing the plate-member-laminated-body in the method for producing a bonded body of different materials of the present embodiment, and FIG. 2 is a diagram schematically describing a bonded body of different materials obtained by the method for producing a bonded body of different materials of the present embodiment. FIG. 3 is a diagram schematically showing the step of heating the plate-member-laminated-body held between a pair of pressing dies in the method for producing a bonded body of the present embodiment. FIGS. 1 to 3 are side views in which the plate-member-laminated-body or the bonded body of different materials is viewed from the side.

The method for producing a bonded body of different materials of the present embodiment comprises producing a plate-member-laminated-body (4) by laminating two plate members (2 and 3), each made of a different material as shown in FIG. 1, and heating the plate-member-laminated-body (4) to produce a bonded body of different materials (1) having the two plate members (2 and 3) bonded as shown in FIG. 2, wherein the method includes a step of heating the above-mention plate-member-laminated-body (4) held between a pair of pressing dies (5) as shown in FIG. 3.

In the method for producing a bonded body of different materials of the present embodiment, there is used a pressing die (5) made of a material having a heat transfer coefficient (W/m²·K) 1.5 times or more higher than that of at least one of the plate members (2 and 3) constituting the plate-member-laminated-body (4), the pressing die (5) having tapered parts (6) between holding surfaces (15) sandwiching the plate-member-laminated-body (4) and fixing ends (16) for securing the pressing die (5), wherein the outer diameter is reduced from the holding surfaces (15) toward the fixing ends (16) as shown in FIG. 3.

This constitution makes it possible to produce a bonded body of different materials (1) having excellent bonding strength in the interface of the two plate-members (2 and 3) (refer to FIG. 2) at low costs.

In a conventional method for producing a bonded body of different materials, the laminated plate members may have fluctuation in the bonding strength in the laminated interface of the two plate members or may have incompletely bonded portions due to difficulty in uniform heat transfer from outside to the plate members sandwiched between a pair of pressing dies. According to a method for producing a bonded body of different materials of the present embodiment, the plate-member-laminated-body (4) can uniformly and efficiently be heated by using a pressing die (5) which is made of a material having a heat transfer coefficient (W/m²·K) 1.5 times or more higher than that of at least one of the plate members (2 and 3) constituting the plate-member-laminated-body (4) and has a tapered part (6) where the outer diameter is reduced from the holding surface (15) toward the fixing end (16).

Thus, since a method for producing a bonded body of different materials of the embodiment can heat the pressing die (5) more promptly than heating the plate-member-laminated-body (4) during the heating step due to the use of the pressing die (5) prepared from the above-mentioned materials and having the above-mentioned configuration and can uniformly transfer heat to the plate-member-laminated-body (4) from the heated pressing die (5), the method can exhibit very high thermal efficiency.

Although not specifically limited, in a method for producing a bonded body of different materials of the present embodiment, the heat transfer coefficient (W/m²·K) of the material forming the pressing die (5) is preferably twice or more, more preferably three times or more, higher than that of at least one of the plate members.

In addition, it is preferable in a method for producing a bonded body of different materials of the present embodiment to use a material for the pressing die (5) having a heat transfer coefficient (W/m²·K) 1.5 times or more higher than the heat transfer coefficient (W/m²·K) of both of the plate members (2 and 3) forming the plate-member-laminated-body (4). This constitution makes it possible to produce a bonded body of different materials (1) having excellent bonding strength (refer to FIG. 2).

When the plate-member-laminated-body (4) is heated in a state that the plate-member-laminated-body (4) is sandwiched between a pair of pressing dies (5), the plate-member-laminated-body (4) can be heated by a heater (7) or the like disposed in the periphery of the pressing dies (5) sandwiching the plate-member-laminated-body (4) as shown in FIG. 3.

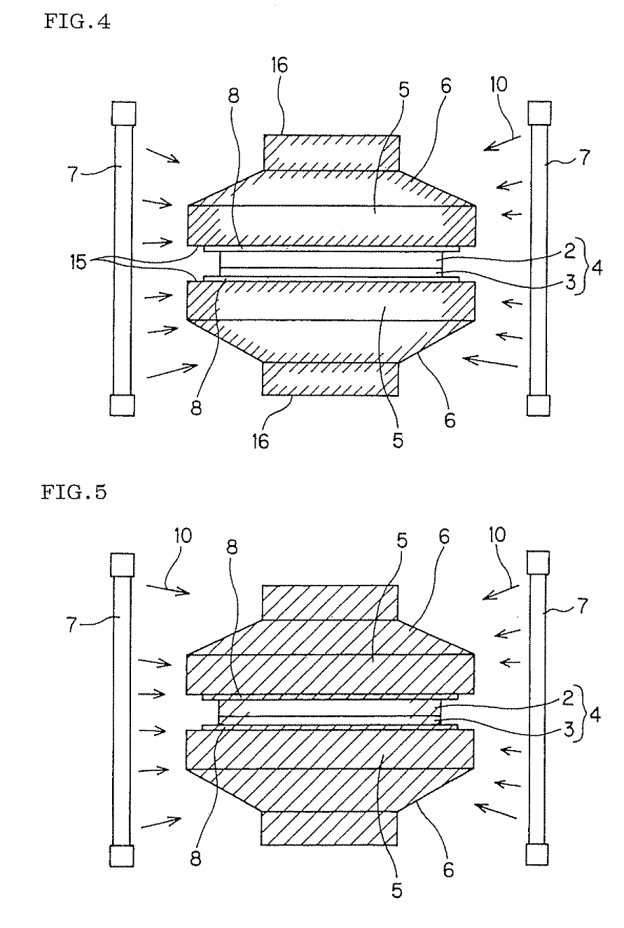

Now, details of the heat transfer during heating will be described below. FIGS. 4 to 6 are diagrams showing the heat transfer conditions during heating in the present method for producing the bonded body of different materials of the present embodiment, wherein the bonded body of different materials is viewed from the side. In FIGS. 4 to 6, the parts of the pressing dies and the plate-member-laminated-body marked with diagonal lines are the parts to which heat is transferred.

When heat is applied from a heater (7), the outside of the pressing dies (5) made of a material having high heat transfer properties is first heated by the radiant heat (10) from the heater (7) as shown in FIG. 4.

In addition, since a pressing die (5) having a tapered part (6) where the outer diameter is reduced from a holding surface (15) toward a fixing surface (16) between the holding surface (15) and the fixing surface (16) is used, the central part of the holding surface (15), to which heat is transferred only with difficulty if a common method is used, is heated well by heat transfer from the tapered part (6), whereby the holding surface (15) of the pressing die is uniformly heated.

Furthermore, the pressing die (5) having the above-mentioned configuration can be heated with excellent thermal efficiency due to the easy absorbing capability of the radiant heat (10).

When known pressing dies with a shape of a, for example, square pillar or a cylinder, for example, are used for holding a plate-member-laminated-body, it takes a long time until entire pressing dies are heated. If such pressing dies are used, it is impossible to uniformly heat the plate-member-laminated-body, since the plate-member-laminated-body is heated from the outside of the holding surface before the holding surface is uniformly heated.

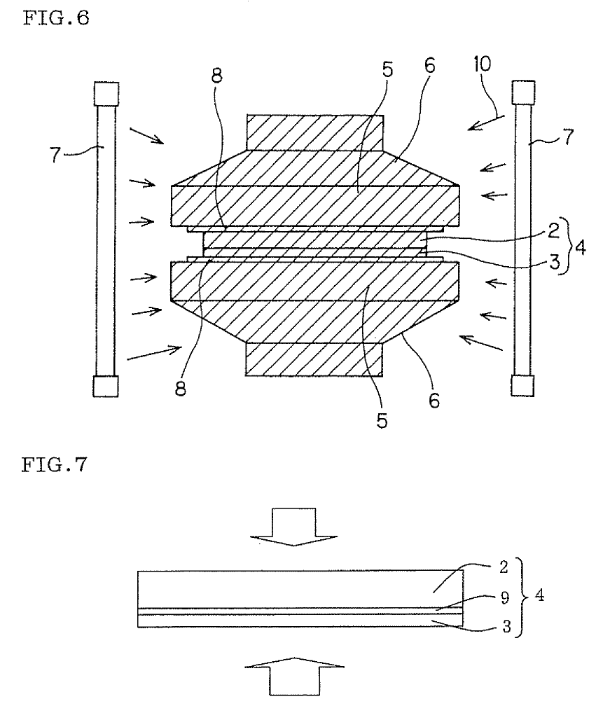

In the method for producing a bonded body of different materials of the present embodiment, after the entire pressing die (5) with good heat transmission has been heated as shown in FIG. 5, the heat is transferred to the plate-member-laminated-body (4) from the holding surface (15) of the heated pressing die (5) as shown in FIG. 6. In this instance, since the pressing dies (5) are heated up to almost even temperature by rapid heating, the heat is uniformly transferred to the surface of the plate-member-laminated-body (4) from the holding surface (15) of the pressing die (5).

The laminated plate-members (2 and 3) can uniformly be heated in this manner, whereby defective bonding can effectively be reduced, and a bonded body of different materials having excellent bonding strength in the bonded interface can be produced.

Since the pressing die (5) is used in the heating step, it is preferable to use a pressing dies (5) made of a material having a melting point of 500° C. or more and 1.5 times or more higher than the bonding temperature of plate-members (2 and 3) constituting the plate-member-laminated-body (4). Pressure can sufficiently be applied to the plate-member-laminated-body (4) of the pressing die (5) by using such a pressing die (5). After producing the bonded body of different materials, the pressing die (5) can easily be removed and repeatedly be used. Furthermore, heat deformation of the pressing die (5) in the heating step can be reduced.

The bonding temperature refers to temperature at which the plate members to be bonded are heated and specifically refers to the maximum temperature reached when heated.

Although not specifically limited, the melting point of the pressing die (5) is preferably 1,000° C. or more, and more preferably 1,500° C. or more. The plate-member-laminated-body can firmly be sandwiched in the heating step by using such a material. The melting point of the pressing die (5) is preferably twice or more higher than that of the aforementioned bonding temperature.

Any material having a heat transfer coefficient (W/m²·K) 1.5 times or more higher than the heat transfer coefficient (W/m²·K) of at least one of the plate members (2 and 3) which form the plate-member-laminated-body can be used as the material of the pressing die (5). For example, materials containing at least one selected from the group consisting of silver, copper, gold, aluminum, magnesium, brass, tungsten, beryllium, iridium, molybdenum, silicon, carbon, aluminum nitride, and silicon carbide are preferably used.

Among these materials, tungsten, molybdenum, carbon, aluminum nitride, and the like are more preferably used. Furthermore, from the viewpoint of availability at a low cost and excellent processability, carbon is particularly preferable.

The heat transfer coefficient of the above-mentioned carbon (e.g. isotropic graphite carbon) significantly varies according to its density. For this reason, when using carbon as a material of the pressing dies in the method for producing a bonded body of different materials of the present embodiment, the density of the carbon is preferably 1.5 Mg/m³ or more, and more preferably 1.7 Mg/m³ or more.

Since carbon with such a density has higher heat transfer properties as compared with materials used for conventional pressing dies and a very high melting point, it can be used in a method for producing bonded bodies of different materials using plate members of various materials.

The pressing die (5) constituted in this way has excellent heat transfer properties and can quickly be heated by the radiant heat (10) of the heater (7) and the like.

In order to ensure uniform heat transfer from the holding surfaces (15) of the pressing dies (5) to the plate-member-laminated-body (4), the plate-member-laminated-body (4) is preferably held in contact with the holding surfaces (15) of the pressing dies (5) without a gap between them.

When the plate-member-laminated-body (4) is held by the pair of pressing dies (5), it is preferable to dispose a releasing material (8) (in FIG. 3, a releasing material (8) in the form of a sheet) between the plate-member-laminated-body (4) and the pair of pressing dies (5) in advance so as not to produce a gap between the pressing dies (5) and the plate-member-laminated-body (4).

This constitution is effective for preventing the plate-member-laminated-body (4) (or the resulting bonded body of different materials (1) (refer to FIG. 2)) from bonding by fusion to the holding surface (15) of the pressing die (5) and for increasing adhesion of the plate-member-laminated-body (4) to the pressing die (5).

Although the releasing material (8) in FIG. 3 has the shape of a sheet, for example, a releasing material in the form of powder (not illustrated) may be used. When such a releasing material in the form of powder is used, the powdered releasing material is spread between the pressing dies and the plate-member laminated body, whereby the powdered releasing material enters into depressions and protrusions on the surface of the pressing dies or the plate-member laminated body, fills the gaps between the pressing dies and the plate-member laminated body, increases heat transmission from the pressing dies, and equalizes the surface pressure distribution.

When a releasing material in the form of a sheet is used, it is preferable that the modulus of elasticity of the releasing material be sufficiently small. Specific modulus of elasticity of the releasing material is preferably 100 GPa or less, and more preferably 10 GPa or less. This configuration makes it possible to fill in the gap between the pressing dies and the plate members, improve the adhesion and heat transfer, and equalize the surface pressure distribution.

The releasing material (8) is preferably a material with excellent heat transmission. Although it is not particularly limited, a releasing material containing at least one material (e.g. sheet-like material or powdery material) selected from the group consisting of silicon, carbon, aluminum nitride aluminum oxide, and silicon carbide is preferably used.

When the releasing material has the form of a sheet, it is desirable that the thickness be sufficiently small, preferably 1 mm or less, and more preferably 0.2 mm or less. When the releasing material is a powder, it is desirable that the particle diameter be sufficiently small, preferably 0.1 mm or less, and more preferably 0.01 mm or less.

It is possible to improve adhesion of the plate-member-laminated-body (4) with the pressing die (5) and uniformly transfer the heat from the holding surface (15) of the pressing die (5) to the surface of the plate-member-laminated-body (4) by using such a releasing material (8).

When a powder is used as a releasing material, it is preferable to sufficiently press the plate-member-laminated-body and the releasing material using a pair of pressing dies after the powder has been supplied between the pressing dies and the plate-member-laminated-body to fill in the gap between the pressing dies and the plate-member-laminated-body to enhance the heat transfer from the pressing dies, before heating the plate-member-laminated-body.

When the plate-member-laminated-body (4) is sandwiched by a pair of pressing dies (5) in the method for producing a bonded body of different materials of the present embodiment, it is preferable to, for example, press the plate-member-laminated-body (4) under a pressure of 0.1 to 100 MPa by the pressing dies (5) although specific pressure vary according to the form and structures of the plate members (2 and 3) laminated. It is possible to correct warping generated after bonding the plate members (2 and 3) and to obtain a bonded body of different materials (1) without distortion (refer to FIG. 2) by applying pressure in this manner.

Although there are no specific limitations on the material of the two plate members (2 and 3) constituting the plate-member-laminated-body (4) as shown in FIG. 1, a metal or an alloy which can cause at least one phase transformation selected from the group consisting of martensitic transformation, bainite transformation, and pearlite transformation by cooling of the austenite phase can be used for one of the plate members (2 and 3) (for example, a plate material 2).

When these metals or alloys are used for one of the plate members (2) of the two plate members (2 and 3), a plate member made of an ultra hard tungsten carbide alloy can preferably be used for the plate member (3).

A bonded body of different materials (1) (refer to FIG. 2) requiring excellent wear resistance only in a part, such as a die used for extrusion forming, can be produced by using such two plate members (2 and 3).

When a plate-member-laminated-body (4) is obtained by laminating two plate members (2 and 3) of different materials in the method of the embodiment, it is possible to obtain a plate-member-laminated-body (4) having a brazing material (9) disposed between the two plate-members (2 and 3) by laminating the two plate members (2 and 3) with a brazing material (9) interposed between the two plate-members (2 and 3), for example, as shown in FIG. 7. By employing this constitution, bonding of the two plate members (2 and 3) becomes easy and the bonding strength can be improved in the interface of the two plate members (2 and 3).

Although the brazing material (9) is not particularly limited, a material which can permeate at least one of the two plate-members (2 and 3) is preferably used as the brazing material (9). Such a material does not remain as a layer between the two plate-members (2 and 3) after bonding, thereby preventing a decrease in the mechanical strength due to residual brazing material (9).

As a suitable example of the brazing material (9) used in the method for producing the bonded body of different materials of the present embodiment, at least one brazing material selected from the group consisting of copper, silver, gold, nickel, and aluminum can be given.

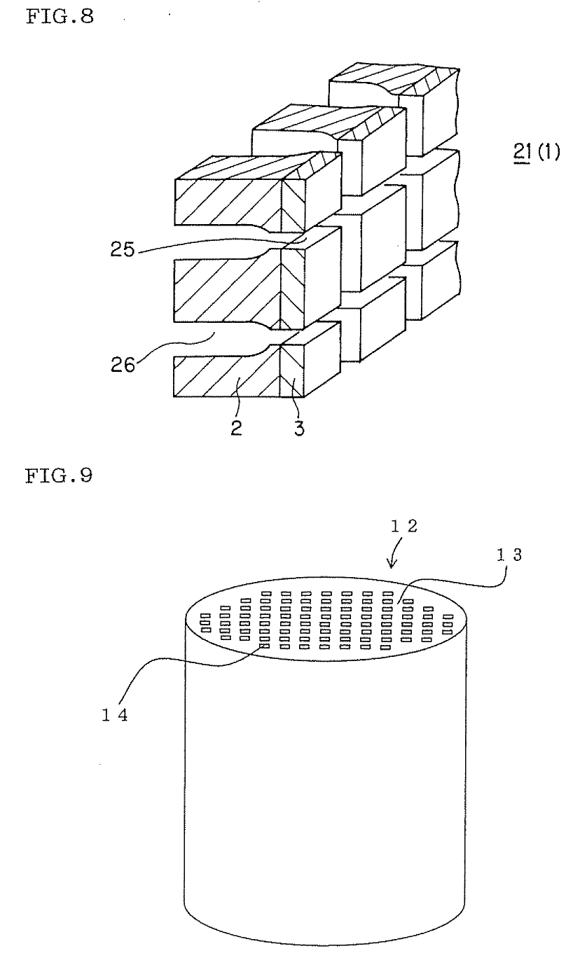

In the method for producing the bonded body of different materials of the present embodiment, it is possible, for example, to produce a die (21) for manufacturing a honeycomb structure as shown in FIG. 8 as a bonded body of different materials by forming back holes to introduce a forming raw material into one of the plate members (2) of the bonded body of different materials and arranging slits for forming a forming raw material into the lattice shape in the other plate member (3).

Such a die (21) is a die (21) made of a bonded body of different materials (1) formed by bonding the plate member (2) having a back hole (26) for introducing a forming raw material and the plate member (3) having slits (25) for forming a forming raw material in the lattice shape.

As shown, for example, in FIG. 9 the die (21) can be used for extrusion-forming a honeycomb structure (12) having porous partition walls (13) and a plural number of cells (14) partitioned and formed by the partition walls (13) and functioning as fluid passages.

The honeycomb structure (12) as shown in FIG. 9 can suitably be used as a catalyst carrier using catalytic action in combustion engines, boilers, chemical reactors, and reformers of fuel cells; and a filter for trapping particulate matter contained in exhaust gas; and the like.

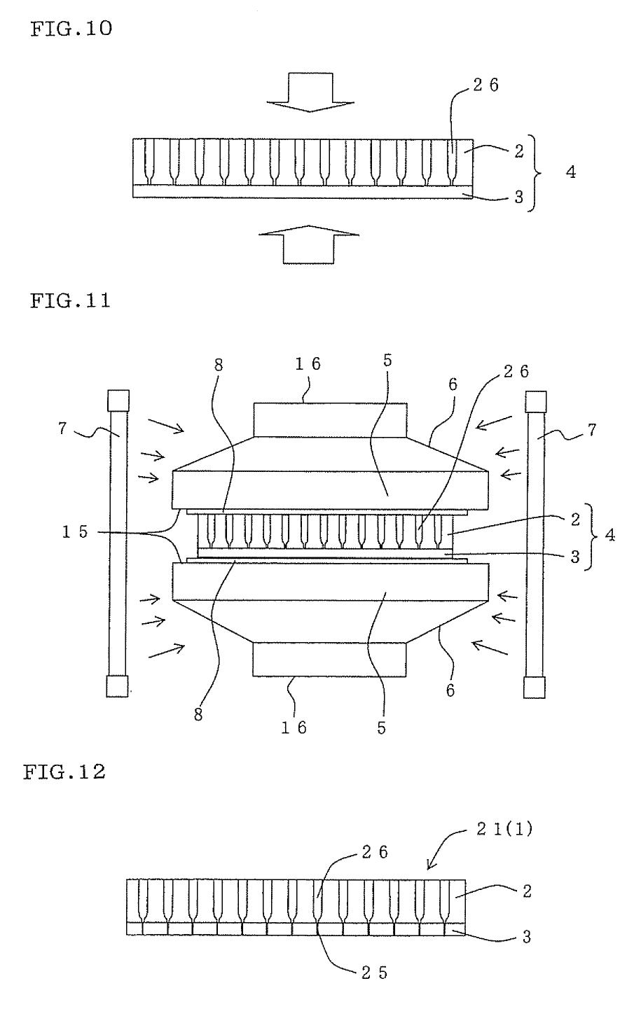

When the die (21) as shown in FIG. 8 is produced, one of the plate member (2) of the two plate members (2 and 3) is provided with back holes (26), and this plate member (2) with back holes is laminated with the other plate member (3) to obtain the plate-member-laminated-body (4), as shown in, for example, FIG. 10.

The above-mentioned back hole (26) can be formed by a known method such as, for example, electro-chemical machining (ECM processing), electrical discharge machining (EDM processing), laser processing, mechanical machining using a drill, and the like.

Next, the resulting plate-member-laminated-body (4) is heated in the state that the resulting plate-member-laminated-body (4) is held between a pair of pressing dies (5) each made of a material containing carbon as the main material and having a tapered part (6) between a holding surface (15) and a fixing end (16), reducing the outer diameter from the holding surface (15) toward the fixing end (16), as shown in FIG. 11 to bond the two plate members (2 and 3) constituting the plate-member-laminated-body (4).

Next, slits (25) for forming a forming raw material in the lattice shape are formed in the other plate member (3) to obtain a die (21) (bonded body of different materials (1)) for forming a honeycomb structure as shown in FIG. 12.

The above-mentioned slits (5) can be formed by a known method such as grinding using a diamond grind stone electrical discharge machining (EDM processing), or the like.

When such a die (21) is particularly produced, a die (21) having excellent wear resistance can be produced by using a metal or an alloy which can cause at least one phase transformation selected from the group consisting of martensitic transformation, bainite transformation, and pearlite transformation by cooling of an austenite phase as the material for the plate member (2) and a tungsten-carbide hard metal for the other plate member (3).

Although a method for producing a bonded body of different materials of the present invention is a method for producing a bonded body of different materials where two plate members, each made of a material different from the other, are bonded, it is needless to mention that the method can be applied to producing a plate member bonded body from two plate members made of the same kind of materials. Such a plate-member-bonded body consisting of two identical plate members can be produced in the same manner as the method for producing a bonded body of different materials described above except for using the two plate members made of the same material.

### INDUSTRIAL APPLICABILITY

A method for producing a bonded body of different materials of the present invention can suitably be used for producing a bonded body of different materials by bonding two plate members, each made of a different material, particularly a bonded body of different materials such as a die used for extrusion forming requiring high wear resistance in only a part thereof.

1. A method for producing a bonded body of different materials comprising obtaining a plate-member-laminated-body by laminating two plate members, each made of a different material, and heating the plate-member-laminated-body to obtain a bonded body of different materials consisting of the two plate members bonded; wherein the method includes a step of heating the plate-member-laminated-body in a state that the plate-member-laminated-body is held between a pair of pressing dies, which are made of a material having a heat transfer coefficient (W/m²·K) 1.5 times or more higher than the heat transfer coefficient (W/m²·K) of at least one of the plate members constituting the plate-member-laminated-body, the pressing dies having tapered parts between holding surfaces holding the plate-member-laminated-body and fixing ends for securing the pressing dies, of which the outer diameter decreases from the holding surfaces toward the fixing ends.

2. The method according to claim 1, wherein the pressing dies are made of a material having a heat transfer coefficient (W/m²·K) 1.5 times or more higher than the heat transfer coefficient (W/m²·K) of both of the plate members constituting the plate-member-laminated-body.

3. The method according to claim 1, wherein the pressing dies are made of a material having a melting point of 500° C. or more and 1.5 times or more higher than the bonding temperature of the plate-members constituting the plate-member-laminated-body.

4. The method according to claim 1, wherein the material of the pressing dies is a material containing at least one selected from the group consisting of silver, copper, gold, aluminum, magnesium, brass, tungsten, beryllium, iridium, molybdenum, silicon, carbon, aluminum nitride, and silicon carbide.

5. The method according to claim 1, wherein the two plate members are laminated with a brazing material between them to obtain a plate-member-laminated-body with a brazing material between the two plate members.

6. The method according to claim 1, wherein the plate-member-laminated-body is held with a releasing material provided in advance between a pair of pressing dies and a plate-member-laminated-body.

7. The method according to claim 6, wherein the releasing material is in a form of a sheet or a powder of at least one material selected from a group consisting of silicon, carbon, aluminum nitride, aluminum oxide, and silicon carbide.

8. The method according to claim 6, wherein the plate-member-laminated body is held by a pressure of 0.1 to 100 MPa applied by the pressing dies.

9. The method according to any claim 1, wherein the material of one of the plate members is a metal or an alloy which can cause at least one phase transformation selected from a group consisting of martensitic transformation, bainite transformation, and pearlite transformation by cooling of an austenite phase.

10. The method according to claim 9, wherein the other plate member is made of an ultra hard tungsten carbide alloy.

11. The method according to claim 1, wherein the material of one of the plate members is provided with a back hole to introduce a forming raw material and slits for forming the forming raw material in a lattice shape, and the resulting bonded body of different materials is used as material for a die for forming a honeycomb structure.
